(19) United States
(12) Patent Application Publication
(10) Pub. No.: US 2002/0046635 A1
(43) Pub. Date: Apr. 25, 2002

(54) Card punching machine

(76) Inventors: Paul Christen, Aarau (CH); Dino Arzensek, Reitnau (CH)

Correspondence Address: William H. Logsdon, WEBB ZIESENHEIM LOGSDON ORKIN & HANSON, P.C., 700 Koppers Building, 436 Seventh Avenue, Pittsburgh, PA, 15219-1818, US

(21) Appl. No.: 09/951,360

(22) Filed: Sep. 13, 2001

(30) Foreign Application Priority Data
Sep. 13, 2000 (CH) 1777/00

(51) Int. Cl. B26D 5/08

(52) U.S. Cl. 83/613

(57) ABSTRACT

The card punching machine has a hollow cylindrical punching tool (12) which is driven into a flat sheet (10) to be punched. The sheet (10) is punched on a plastic back-pressure plate (8) and is essentially made of polycarbonate or a laminate that includes at least one layer made of polycarbonate. The card punching machine can be used to manufacture high-quality cards from polycarbonate or from the above mentioned laminate.

### BACKGROUND OF THE INVENTION

1. Field of the Invention

This invention relates to a card punching machine for the manufacture of plastic cards.

2. Brief Description of the Prior Art

The punching of plastic cards such as credit cards and identification cards has long been done using card punching machines that have a punch or tool and a die. The sheet to be punched can be a laminate, for example, which is placed on the die. For punching, the punch is lowered and thereby punctures the surface of the sheet to be punched and penetrates with its forward end into the die opening. The card thus punched out is pushed by the punch into the opening in the die and is removed through the opening in the die. Such punches and dies are relatively complex and expensive to manufacture, and adapting them to different card dimensions is a time-consuming process. The punch and the die also have to be regularly adjusted for accuracy of register. Because the punch is introduced into the die opening, regular regrinding of the punch and of the opening in the die is necessary.

The machines of the prior art can be used to manufacture cards made of PVC with sufficiently clean edges. On the other hand, high-quality cards made of polycarbonate or a laminate that contains polycarbonate cannot be manufactured because the edges of the punched cards have “eyebrows”, which in many cases are unacceptable.

### SUMMARY OF THE INVENTION

The object of the invention is to create a card punching machine of the type described above, the manufacture and maintenance of which is more economical, and which is better suited for, among other things, punching cards made of polycarbonate.

The invention teaches a card punching machine in which the sheet of plastic is punched on a back-pressure plate made of plastic, and the sheet to be punched is made essentially of polycarbonate or a laminate that includes at least one layer made of polycarbonate.

It has been discovered that cards with clean edges without “eyebrows” can be punched out of polycarbonate using the card punching machine taught by the invention. Close tolerances can be achieved on account of the clean edges that can be achieved. The card punching machine claimed by the invention is particularly economical, because the punching tools and back-pressure plates are significantly more economical than the tools and dies of the prior art. It is significantly easier to adapt the machine to different card dimensions because only the punching tool needs to be changed. The process of aligning the card punching machine claimed by the invention is particularly simple, because the adjustment of the accuracy of register of the tool and die required on machines of the prior art is no longer necessary. The plastic back-pressure plate can be replaced very easily at regular intervals.

Additional advantageous features of the invention are described in greater detail below, in the dependent claims and in the accompanying drawing.

### BRIEF DESCRIPTION OF THE DRAWINGS

One exemplary embodiment of the invention is explained in greater detail below with reference to the drawing, in which:

FIG. 1 is a schematic illustration of a section through a card punching machine as claimed by the invention;

FIG. 2 is a schematic cross section through one variant of the card punching machine claimed by the invention; and

FIG. 3 is a schematic cross section through a card punching machine of the prior art.

### DETAILED DESCRIPTION OF THE PREFERRED EMBODIMENT

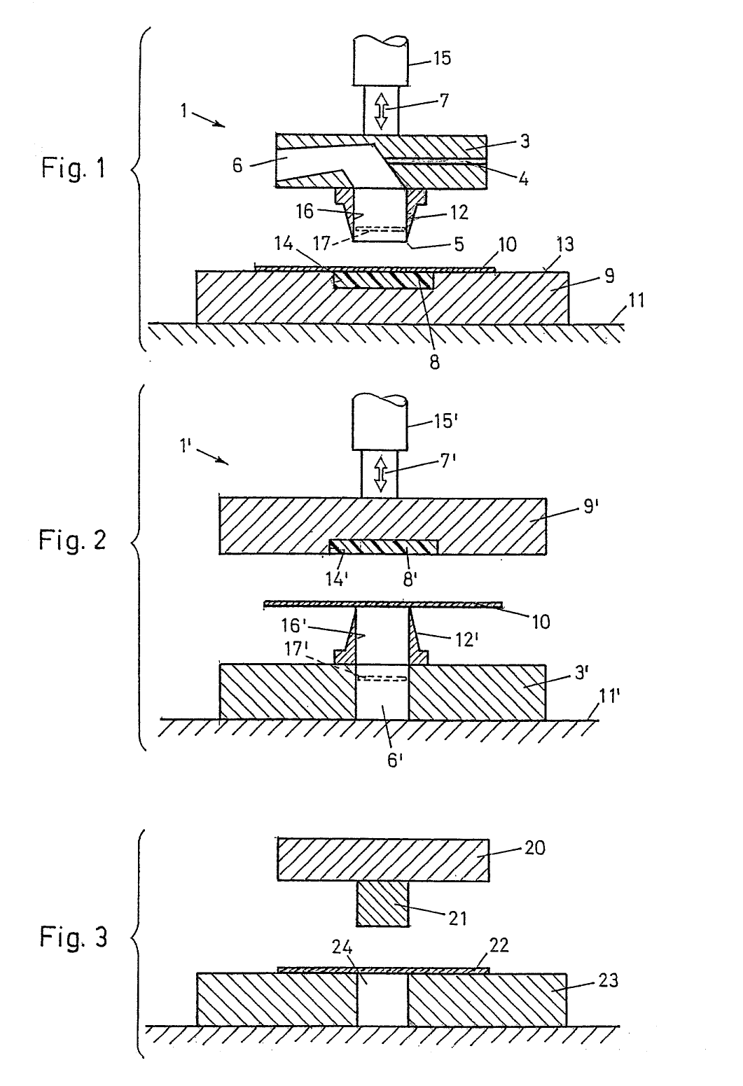

FIG. 1 shows a card punching machine 1 which has a plate holder 9 which is fastened to a table 11. Worked into an upper side 13 of the plate holder 9 is a recess 14 in which a back-pressure plate 8 is inserted. This plate 8 is preferably made of plastic, in particular Erthalon 6SA or another similar material. The upper side of the back-pressure plate 8 is essentially flush with the upper side 13 of the plate holder 9. A flat sheet 10 to be punched is laid on the upper side 13 of the plate holder 9. This punching sheet 10 is fed to the machine by devices not shown here. The sheet 10 to be punched is made of polycarbonate or a laminate that contains at least one layer made of polycarbonate.

Located above the plate holder 9 on a drive 15 is a punching tool holder 3, which holds a hollow cylindrical punching tool 12 with a forward cutting edge 5. The cutting edge 5 corresponds to the contour of the card to be punched. The drive 15 is realized so that it can move the punching tool holder 3 down and up by a specified distance in the directions indicated by the double arrow 7. A passage 16 in the cutting blade 12 is connected with a discharge duct 6 into which a compressed air duct 4 empties. This discharge duct 6 is open on the side, as shown in the drawing.

To punch a card 17 from the sheet 10, the punching tool holder 3 with the punching tool 12 is moved downward. The punching tool 12 thereby penetrates with its cutting edge 5 the sheet 10 to be punched and thereby punches out the card 17. The punching tool 12 thereby penetrates slightly with its cutting edge 5 into the back-pressure plate 8. The punched card 17 is moved into the passage 16 as illustrated by the broken lines in FIG. 1. The cards subsequently punched out accumulate in the passage 16, and the topmost card 17 is thereby moved upward until it is pushed to the left, out of the discharge channel 6, by the air flowing in from the compressed air duct 4 shown in FIG. 1. Individual cards are thereby punched out of the sheet 10 using the card punching machine 1. After each punching process, the punching sheet 10 is repositioned, which can be done using devices of the prior art.

FIG. 2 shows a card punching machine 1′ which differs from the one illustrated in FIG. 1 in that a punching tool holder 3′ with a punching tool 12′ is mounted in a stationary manner on the table, while for punching, a plate holder 9′ is moved vertically. The sheet 10 to be punched is laid on the punching tool 12′ to be punched. The cards that are punched out travel downward into a vertical discharge channel 6′. For punching, this card punching machine 1′ also has a back-pressure plate 8′ which is made of plastic. The punching tool 12′ corresponds in terms of shape and realization to the punching tool 12 mentioned above. However, it does not move but is mounted so that it remains stationary.

FIG. 3 is a schematic illustration of a card punching machine of the prior art. This machine of the prior art has, on a tool holder 20, a tool 21 which is moved downward by a specified distance and thereby punches the punching sheet 22 as it lies on an opening 24 of a die 23. The tool 21 thereby penetrates into the opening 24. The tool 21 must be oriented correctly with respect to the opening 24. Both the tool 21 and the die 23 must be given regular maintenance, and must be reground, among other things.

What is claimed is:

1. A card punching machine for the manufacture of plastic cards (17) such as identification cards and credit cards, the card punching machine comprising: a hollow cylindrical punching tool (12) driven into a punching sheet (10) and a back-pressure plate (8), wherein the punching sheet (10) is punched on the back-pressure plate (8), the back-pressure plate (8) made of plastic and the punching sheet (10) made essentially of polycarbonate or a laminate that contains at least one layer of polycarbonate.

2. The card punching machine as claimed in claim 1, wherein the hollow cylindrical punching tool (12) is connected with a discharge channel (6) into which punched cards (17) are pushed by the next cards punched, and are removed via this channel (6).

3. The card punching machine as claimed in claim 1, wherein the back-pressure plate (8) is located on a stationary holder (9) and that for punching, the punching tool (12) is moved toward the back-pressure plate (8).

4. The card punching machine as claimed in claim 1, wherein the punching tool (12) is located on a stationary holder (9) and that for punching, the back-pressure plate (8) is moved toward the punching tool (12).
